(19) United States
(12) Patent Application Publication
(10) Pub. No.: US 2011/0100887 A1
(43) Pub. Date: May 5, 2011

(54) Downspout debris collector

(76) Inventor: Matteo Giuseppe Ballistreri, Morristown, NJ (US)

(21) Appl. No.: 12/590,143

(22) Filed: Nov. 4, 2009

(51) Int. Cl. C02F 1/00

(52) U.S. Cl. 210/170.03

(57) ABSTRACT

The Downspout Debris Collector is a water filter (D) located approximately four feet above the ground inside a fifteen inch section of downspout. (A) It is inserted into an eleven inch opening cut into an existing downspout. This filter is a ¼ inch holed wire screen (B) riveted horizontally inside five inches from the bottom of the fifteen inch section. (C) Debris collectors in roof gutters are strainers, called “birdcages” that are located in the gutters where the gutters are jointed with the downspouts. This strainer is accessible only at roof height and cleaning it requires considerable effort. The Downspout Debris Collector being four feet from the ground is easily accessed. To clean it raise it until the bottom portion is free, remove it, turn it upside down, empty the debris and then replace it. This unit ELIMINATES debris from clogging underground pipes saving building foundations and money.

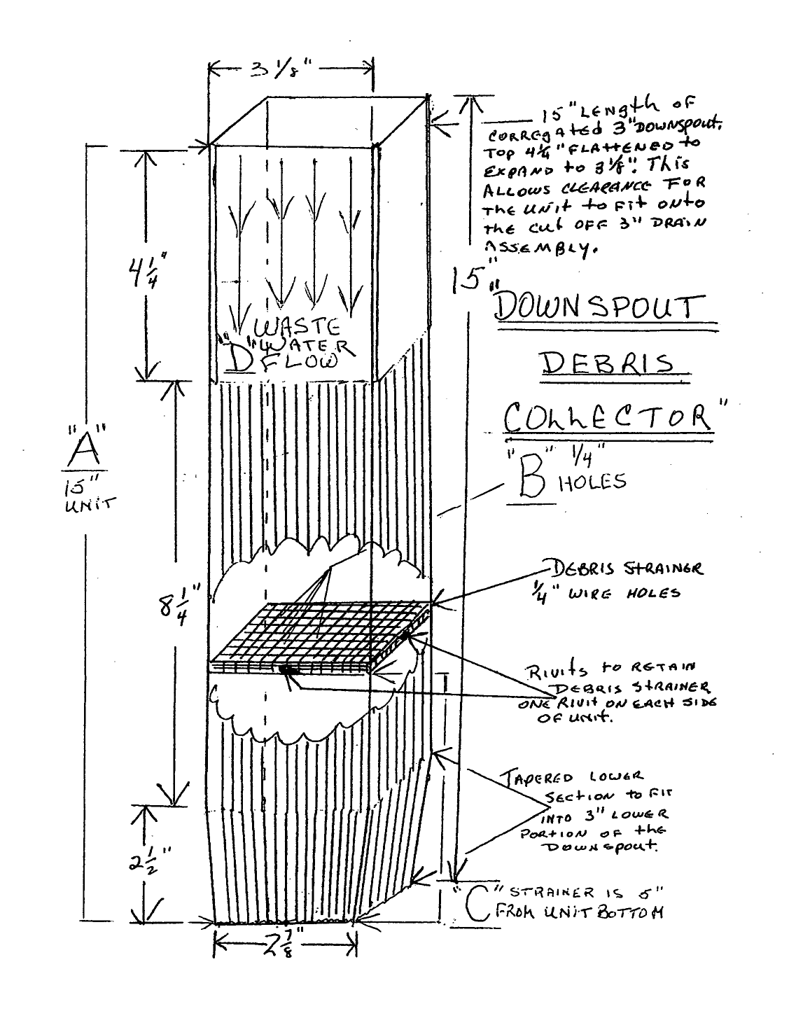

The Downspout Debris Collector is a 15″ length of 3″ or 4″ traditional corrugated downspout. The top 4¼ of the 15″ unit is not corrugated and thereby a larger opening than the remainder of the unit. Four inches above the bottom inside of the unit is installed a screen with ¼″ holes. This screen is fastened to the four sides of the unit with one rivet on each side. The bottom 2½″ of the unit is slightly crimped so that it can be easily inserted into an existing downspout.

To install the Downspout Debris Collector cut out 11″ from an existing operating downspout approximately 4′ from the ground. Slide the larger end of the unit up over the upper potion of the cut downspout. Slide it up until the lower portion of the unit clears the lower cut downspout opening. Slide the unit down so the lower portion fits snugly into the lower downspout opening.

To service the unit firmly grip the center of the unit and slide it up until the unit is free on the bottom then pull the lower end of the unit out far enough so the top of the unit can be pulled down away from the existing downspout. To clean the unit simply turn the unit over, empty out the debris and reinstall.

1. When installed the Downspout debris collector will collect any debris larger than ¼″ capable of clogging a drainage pipe at the end of a downspout. The Downspout Debris Collector, by collecting debris, allows underground drainage pipes to run clearly so that rainwater flows away safely to where it was designed to go. It is easily removed for cleaning by simply turning the upside allowing the collected debris to fall out thereby making the unit clear and clean of any obstruction. There are no moving parts and will last as long as the system that it is installed into.
